(19) United States
(12) Patent Application Publication
(10) Pub. No.: US 2010/0076683 A1
(43) Pub. Date: Mar. 25, 2010

(54) CAR AND SHIP BLING SPOT-FREE COLLISION AVOIDANCE SYSTEM

(75) Inventor: RONG-HER CHOU, Yu-Lin Hsien (TW)

Correspondence Address: WPAT, PC;INTELLECTUAL PROPERTY ATTORNEYS, 7225 BEVERLY ST., ANNANDALE, VA, 22003, US

(73) Assignee: TECH-CAST MFG CORP., Yu-Lin Hsien (TW)

(21) Appl. No.: 12/237,859

(22) Filed: Sep. 25, 2008

(51) Int. Cl. G08G 1/16; G01S 13/93; H04N 7/18; G08G 3/02

(52) U.S. Cl. 701/301; 342/41; 348/139

(57) ABSTRACT

A car and ship blind spot-free collision avoidance system includes a plurality of image acquiring units and detecting units externally spaced along the car or the ship, an image processing unit, at least one image display unit, and a power supply unit, all being electrically connected to a control unit. The power supply unit supplies power needed by the system to operate normally. The control unit can determine the car or the ship position and moving direction via gear position of a shift lever and turning direction of a steering wheel, and enable real-time images shot by the image acquiring units corresponding to that position or direction to be processed by the image processing unit and then synchronously displayed on a split screen of the image display unit, so as to eliminate blind spots in driving the car or steering the ship and minimize collision and other accidents.

### FIELD OF THE INVENTION

The present invention relates to a car and ship blind spot-free collision avoidance system, and more particularly to a blind spot-free collision avoidance system that can automatically detect moving directions of a car or a ship and enables images shot by one or more image acquiring units mounted on the car/ship at predetermined positions to be synchronously displayed on an image display unit.

### BACKGROUND OF THE INVENTION

Following the progress and development of the modern society, most people can afford a car now. As a result, the number of various cars running on the roads constantly increases to further complicate the urban traffic, and the old streets seem to be quite narrow compared to the large number of cars. A driver must be very careful when driving, parking, or reversing a car to avoid collision with other cars or external objects. Moreover, when driving a car, particularly a large-size car, such as a van, a truck, or a touring bus, there are always blind spots that can not be viewed by a driver during driving, no matter how careful the driver is. An accident and tragedy would occur when someone, particularly a child or an old man, or some animal unexpectedly moves into any of such blind spots when the car is moving.

While large-size ships being tugged by tugboats into or out of a harbor do not have the problem of collision with other ships easily, middle-size ships or yachts are subject to such dangers. It is not likely for a ship to hit a person. However, a ship may still collide with an external object due to the steersman's negligence. When this happens, the ship would usually have a spoiled appearance. In some worse conditions, such as colliding with a bow of a rear ship, the ship might have a broken hull to result in percolation or other serious damages.

### SUMMARY OF THE INVENTION

A primary object of the present invention is to provide a car and ship blind spot-free collision avoidance system, which can automatically detect the car/ship for its moving directions and enables images shot by one or more image acquiring units mounted on the car/ship at predetermined positions to be synchronously displayed on a split screen of an image display unit for a driver's or a steersman's reference.

Another object of the present invention is to provide a car and ship blind spot-free collision avoidance system, which includes detecting units externally spaced along a car or a ship, so that these detecting units emit warning sound and warning signal to alert a driver or a steersman when any external object is detected within a preset distance.

To achieve the above and other objects, the car and ship blind spot-free collision avoidance system according to the present invention is installed on a car or a ship to provide necessary image and distance surveillance to conditions outside the car or the ship, and includes a plurality of image acquiring units, an image processing unit, a control unit, at least one image display unit, a plurality of detecting units, and a power supply unit. The image acquiring units and the detecting units are externally spaced along the car or the ship. The control unit is electrically connected to the image acquiring units, the image processing unit, the image display unit, the detecting units, and the power supply unit. The power supply unit supplies power needed by the blind spot-free collision avoidance system to operate normally. The control unit can determine the car or the ship position and moving direction via the gear position of a shift lever and the turning direction of a steering wheel, for example, and enable real-time images shot by image acquiring units corresponding to that position or direction to be processed by the image processing unit and synchronously displayed on a split screen of the image display unit.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a block diagram of a car and ship blind spot-free collision avoidance system according to the present invention;

FIG. 2 is a schematic diagram showing the blind spot-free collision avoidance system of the present invention is applied to a ship; and

FIG. 3 is a schematic diagram showing the blind spot-free collision avoidance system of the present invention is applied to a car.

### DETAILED DESCRIPTION OF THE PREFERRED EMBODIMENTS

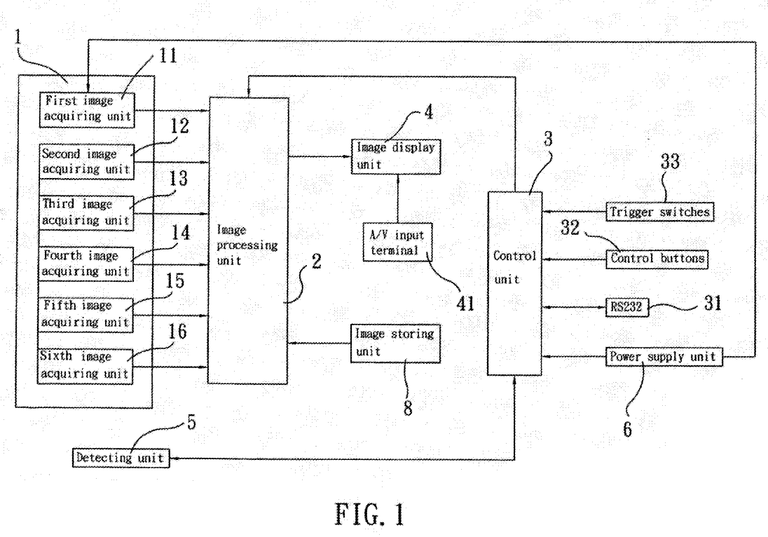

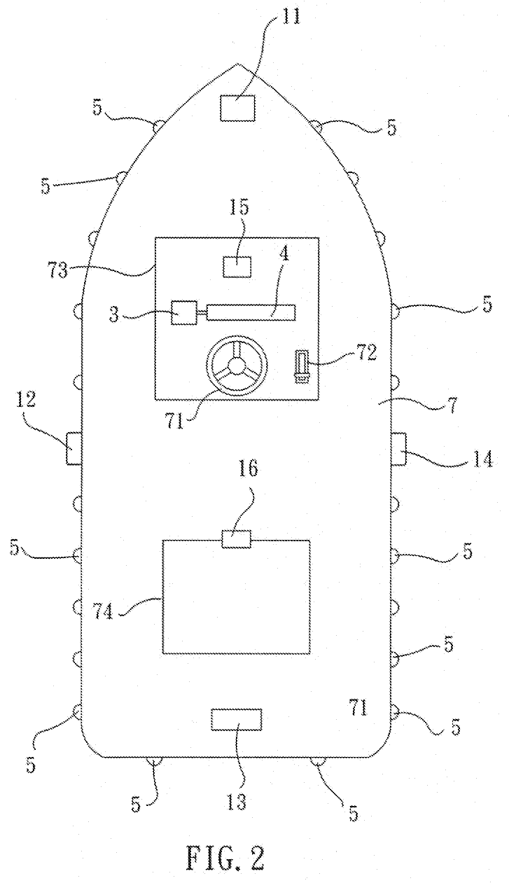

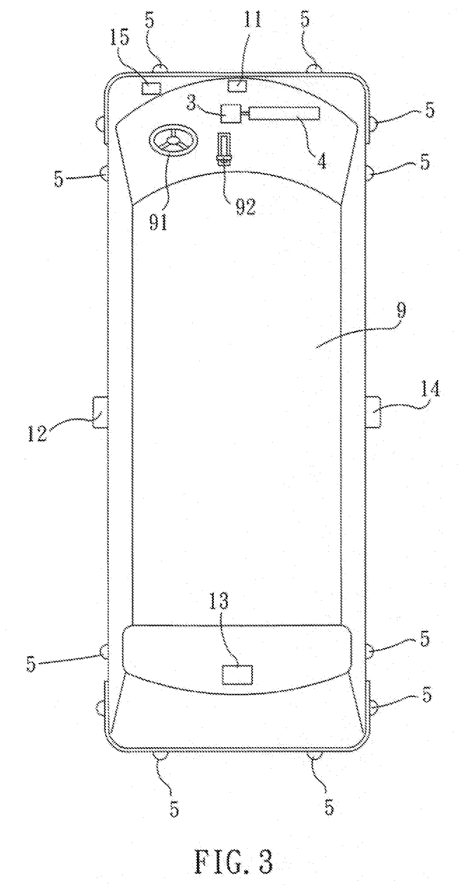

Please refer to FIG. 1, which is a block diagram of the car and ship blind spot-free collision avoidance system according to the present invention. The blind spot-free collision avoidance system is installed on a car or a ship to provide necessary image and distance surveillance to conditions outside the car or the ship. As shown, the blind spot-free collision avoidance system includes a plurality of image acquiring units 1, an image processing unit 2, a control unit 3, at least one image display unit 4, a plurality of detecting units 5, and a power supply unit 6. The image acquiring units 1 and the detecting units 5 are externally spaced along a car 9, as shown in FIG. 3, or a ship 7, as shown in FIG. 2. The control unit 3 is electrically connected to the image acquiring units 1, the image processing unit 2, the image display unit 4, the detecting units 5, and the power supply unit 6. The power supply unit 6 supplies power needed by the blind spot-free collision avoidance system to operate normally. The control unit 3 can determine the car or the ship position and moving direction via the gear position of a shift lever and the turning direction of a steering wheel, for example, and enable real-time images shot by image acquiring units 1 corresponding to that position or direction to be processed by the image processing unit 2 and synchronously displayed on a split screen of the image display unit 4.

Preferably, the image acquiring units 1 each are a camera. The cameras each can be provided with an internal infrared LED (light-emitting diode) as a light source thereof, so that clear images can be acquired when the cameras operate at night. The detecting units 5 each are a distance sensing radar capable of detecting a distance from the car or the ship to an external object. The image display unit 4 is a liquid crystal display (LCD). In the case the distance from the car or the ship to an external object, such as another car or another ship, a wharf, or a shore, is smaller than a preset distance, for example, 5 meters, distance data detected by the detecting units 5 will be displayed on the image display unit 4.

The number and the position of the image acquiring units 1 and the detecting units 5 can be adjusted in accordance with the size of the car 9 or the ship 7.

Referring to FIG. 2, for example, when the present invention is applied to a ship, the image acquiring units 1 include a first image acquiring unit 11 located at the bow of the ship 7, a second image acquiring unit 12 located at the port side of the ship 7, a third image acquiring unit 13 located at the stern of the ship 7, and a fourth image acquiring unit 14 located at the starboard side of the ship 7. The control unit 3 is automatically connected to trigger switches 33 thereof being arranged on different ship control mechanisms, such as a steering wheel 71 for controlling turning directions of the ship 7 and a shift lever 72 for controlling forward/backward movement of the ship 7. Accordingly, the control unit 3 can automatically determine a steersman's intention in steering the ship, and enable images acquired by the image acquiring units 1 located at positions corresponding to the steering direction to be sent to the image processing unit 2. Images having been processed by the image processing unit 2 are integrated and synchronously displayed on a split screen of the image display unit 4 for the steersman's reference in steering the ship 7. In the case the distance from the ship 7 to a wharf or another ship is smaller than a preset distance, the detecting units 5 will timely emit a warning sound to remind the steersman to take immediately and necessary action. Simultaneously, the distance data shown on the image display unit 4 will instantly turn red. Accordingly, when the steersman manipulates the steering wheel while watching the screen of the image display unit 4, the distance data in red color will immediately draw the steersman's attention that the ship is about to collide with an external object, and urge the steersman to take necessary action in response to this situation.

For example, when the control unit 3 detects that the shift lever 72 is shifted to reverse gear position and the steering wheel 71 is turned rightward, this means the ship 7 is about to move backward and rightward. At this point, the third image acquiring unit 13 located at the stern and the fourth image acquiring unit 14 located at the starboard side are actuated to shoot images, which are then shown on the image display unit 4. When the detecting units 5 detect any external object existing within the preset distance, the detecting units 5 will also automatically and timely emit a warning signal. Similarly, in the case the control unit 3 detects that the shift lever 72 is shifted to reverse gear position and the steering wheel 71 is turned leftward, this means the ship 7 is about to move backward and leftward. At this point, the third image acquiring unit 13 located at the stern and the second image acquiring unit 12 located at the port side are actuated to shoot images, which are then shown on the image display unit 4.

Please now refer to FIG. 3, which shows the blind spot-free collision avoidance system is applied to a car 9. In this case, the image acquiring units 1 include a first image acquiring unit 11 located at the head of the car 9, a second image acquiring unit 12 located at the left side of the car 9, a third image acquiring unit 13 located at the tail of the car 9, and a fourth image acquiring unit 14 located at the right side of the car 9. The control unit 3 is automatically connected to trigger switches 33 thereof being arranged at different car control mechanisms, such as a steering wheel 91 for controlling turning directions of the car 9 and a shift lever 92 for controlling forward/backward movement of the car 9. Accordingly, the control unit 3 can automatically determine a driver's intention in steering the car 9, and enable images acquired by the image acquiring units 1 located at positions corresponding to the steering direction to be sent to the image processing unit 2. Images having been processed by the image processing unit 2 are integrated and synchronously displayed on a split screen of the image display unit 4 for the driver's reference in steering the car 9. In the case the distance between the car 9 and another car or some other object, such as a person or an animal, is smaller than a preset distance, the detecting units 5 will timely emit a warning sound and the distance data shown on the image display unit 4 will instantly turn red to remind the driver to take immediately and necessary action in response to this situation.

For example, when the control unit 3 detects that the shift lever 92 is shifted to reverse gear position and the steering wheel 91 is turned rightward, this means the car 9 is about to move backward and rightward. At this point, the third image acquiring unit 13 located at the tail and the fourth image acquiring unit 14 located at the right side are actuated to shoot images, which are then shown on the image display unit 4. When the detecting units 5 detect any external object existing within the preset distance, the detecting units 5 will also automatically and timely emit a warning signal. Similarly, in the case the control unit 3 detects that the shift lever 92 is shifted to reverse gear position and the steering wheel 91 is turned leftward, this means the car 9 is about to move backward and leftward. At this point, the third image acquiring unit 13 located at the tail and the second image acquiring unit 12 located at the left side are actuated to shoot images, which are then shown on the image display unit 4.

In the car and ship blind spot-free collision avoidance system of the present invention, the control unit 3 further includes an RS232 communication interface 31 for integrating relevant driving safety devices. In addition, the image display unit 4 further includes an audio/video (A/V) input terminal 41, via which the image display unit 4 can be connected to an external audio/video apparatus, such as a satellite television or a digital television. Accordingly, the driver or the steersman can watch weather forecast, etc. directly on the image display unit 4 to obtain necessary safety information.

With the above arrangements, the control unit 3 can automatically detect the steering state of the car or the ship and timely switch between the image acquiring units 1. The blind spot-free collision avoidance system of the present invention can also be provided with a plurality of control buttons 32. The driver or the steersman can push the control buttons 32 to manually select the image signals acquired by the image acquiring units 1 to be shown on the image display unit 4.

In addition to the first to fourth image acquiring units 11˜14 externally spaced along the ship 7, the blind spot-free collision avoidance system of the present invention can further include a fifth image acquiring unit 15 mounted in a wheelhouse 73 and a sixth image acquiring unit 16 mounted in an engine room 74 of the ship 7, so that the steersman can operate the control buttons 32 to switch to the fifth and the sixth image acquiring units 15, 16 to watch at any time the conditions in the wheelhouse 73 and the engine room 74 without the necessity of being there personally.

The blind spot-free collision avoidance system of the present invention can further include an image storing unit 8 electrically connected to the image processing unit 2 for copying and filing the images having been processed by the image processing unit 2.

With the present invention, image acquiring units and detecting units can be mounted to outer side of a car or a ship, and images acquired by the image acquiring units when the car or the ship moves toward different directions can be automatically selected via a control unit and processed by an image processing unit for synchronously displayed on a split screen of an image display unit for a driver's or a steersman's reference in steering the car or the ship. When the detecting units detect any external object existing within a preset distance, a warning signal will be timely emitted. Accordingly, with the present invention, blind spots in driving a car or steering a ship can be eliminated to largely increase the safety and convenience in driving the car or steering the ship.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A car and ship blind spot-free collision avoidance system for installing on a car or a ship to provide image and distance surveillance to conditions outside the car or the ship, comprising a plurality of image acquiring units, an image processing unit, a control unit, at least one image display unit, a plurality of detecting units, and a power supply unit; the image acquiring units and the detecting units being externally spaced along the car or the ship; the control unit being electrically connected to the image acquiring units, the image processing unit, the image display unit, the detecting units, and power supply unit; the power supply unit supplying power needed by the system to operate normally; and the control unit being able to determine the car or the ship position and moving direction via gear position of a shift lever and turning direction of a steering wheel, for example, and enable real-time images shot by one or more image acquiring units corresponding to that position or direction to be processed by the image processing unit and then synchronously displayed on a split screen of the image display unit.

2. The car and ship blind spot-free collision avoidance system as claimed in claim 1, wherein the image acquiring units each are a camera.

3. The car and ship blind spot-free collision avoidance system as claimed in claim 2, wherein the cameras each are internally provided with an infrared LED as a light source thereof.

4. The car and ship blind spot-free collision avoidance system as claimed in claim 1, wherein the detecting units are distance sensing radars capable of detecting a distance from the car or the ship to an external object.

5. The car and ship blind spot-free collision avoidance system as claimed in claim 1, wherein the detecting units are actuated to emit a warning signal when the detecting units detect a distance from the car or the ship to an external object is smaller than a preset value.

6. The car and ship blind spot-free collision avoidance system as claimed in claim 1, wherein the control unit includes a plurality of control buttons for a driver or a steersman to push and thereby manually select the image signals acquired by the image acquiring units to be shown on the image display unit.

7. The car and ship blind spot-free collision avoidance system as claimed in claim 1, wherein the image display unit is a liquid crystal display (LCD).

8. The car and ship blind spot-free collision avoidance system as claimed in claim 1, wherein the control unit includes an RS232 communication interface.

9. The car and ship blind spot-free collision avoidance system as claimed in claim 1, wherein the image display unit includes an A/V input terminal.

10. The car and ship blind spot-free collision avoidance system as claimed in claim 1, further comprising an image storing unit electrically connected to the image processing unit for copying and filing the images having been processed by the image processing unit.
